(19) United States
(12) Patent Application Publication
(10) Pub. No.: US 2008/0212441 A1
(43) Pub. Date: Sep. 4, 2008

(54) Apparatus and Method for Digital Content Concealment

(76) Inventor: Stanley Babowicz, Phoenix, AZ (US)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(21) Appl. No.: 10/472,293

(22) PCT Filed: Mar. 13, 2002
(86) PCT No.: PCT/US02/07558

§ 371 Date: Oct. 21, 2005

Related U.S. Application Data
(60) Provisional application No. 60/277,099, filed on Mar. 19, 2001.

(51) Int. Cl. G11B 27/00

(52) U.S. Cl. 369/83

(57) ABSTRACT

A copy protected compact disc (200) preferably is provided with a first session that includes the standard digital audio content (204), in a format that is readable by a conventional CD player. It also includes a second session that is configured to provide a user computer with access to an alternative form of the same digital audio content (210), but that is subject to a digital rights protocol, such as a protocol that requires a key in order to play or copy the audio content Copy protection technology is further provided on the compact disc in order to frustrate a user computer from identifying the standard digital audio content (204) as such and thereby directing the computer to the second session and the alternative audio content (210). The copy protection technology is preferably a configuration of the control data that is located in the lead in area (202) of the compact disc.

### BACKGROUND OF THE INVENTION

1. Field of the Invention

This invention relates in general to the concealment of digital content stored on a storage medium such as a compact disc (CD) and, more specifically, to an apparatus and method for concealing stored digital content from being read by a compact disc read-only memory (CD-ROM) or other digital-based reader or computer device, for example as done when performing digital audio extraction (also known as ripping) of musical content from an audio CD. The apparatus and method of the present invention permit improved control of the distribution of published content on physical media to only authorized users.

2. Description of the Related Technology

The widespread use of personal computers and Internet access-has permitted extensive unauthorized distribution of the publishing industry's content including audio, video, software, images and text. Significant contributing factors to this unauthorized distribution include the large volume of digital content previously acquired by consumers, for example, on audio CD, CD-ROM, CD-R, DVD and DVD-A media and the ease of digital duplication of the music or other content on these physical media Also, the standards used to produce the content for audio CDs (e.g., the EEC 60908 Redbook Standard) were not originally intended to prevent transfer of the content in digital or analog form and do not use methods to conceal the digital data on the CD for preventing unauthorized transfer. Further, copies made using digital processes are of high quality. Even copies using compressed formats such as, for example the standard MPEG Audio Layer 3 (MP3) format or Microsoft's Windows Media format, are of good quality in comparison to prior analog copying approaches.

The music industry in particular has a strong interest in protecting valuable music content from unauthorized copying and distribution, especially over the Internet or through other computer-based copying and distribution using music ripping software or other means. Industry efforts to prevent this unauthorized copying and distribution include the use of content security methods to prevent or control copying of music content by consumers or music pirates. However, because consumers desire to use a wide range of standard CD players, content security methods that interfere with this ready playability may not achieve marketplace acceptance.

Prior digital content concealment approaches to prevent unauthorized distribution have use hardware-based solutions requiring custom hardware to complete the CD mastering process. However, such hardware-based solutions create significant difficulties and add considerable costs for CD manufacturers. Other approaches have relied on-modifying the actual data content of the CD, an approach that is undesirable from the artist, publisher, label and consumer perspectives since said data is unnecessarily corrupted

Hence, there is a need for a digital content concealment approach to secure content on CD and other physical media from unauthorized access and distribution without requiring hardware modifications or modification of the actual data content itself. This approach should permit distribution of such digital content to authorized users and customers and permit the use of standard CD and other players by such users and customers. Further, this approach preferably should aid in tracking unauthorized distribution by permitting the identification of unauthorized copies of digital content.

### SUMMARY OF THE INVENTION

Accordingly, it is an object of the invention to provide a digital content concealment approach to secure content on CD and other physical media from unauthorized access and distribution without requiring hardware modifications or modification of the actual data content itself. It is further in object of the invention to provide an approach that will aid in tracking unauthorized distribution by permitting the identification of unauthorized copies of digital content.

In order to achieve the above and other objects of the invention, a compact disc that is constructed according to a first aspect of the invention includes digital audio content; and a lead-in area that has control data stored thereon, the control data being configured in a manner as to conceal the digital audio content from a user computer.

According to a second aspect of the invention, a multiple session compact disc includes a first session that contains digital audio content, a second session that is configured to provide a user computer with access to an alternative form of the audio content that is subject to a digital rights management protocol, and concealment technology for concealing the presence of digital audio content on the first session to a user computer.

According to a third aspect of the invention, a method of providing copy protection to a compact disc containing digital audio content include steps of applying the digital audio content to the compact disc; and applying a lead-in portion to the compact disc that is configured to frustrate recognition of the digital audio content by a user computer.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a process flow diagram illustrating the manufacture of a compact disc product;

FIG. 2 illustrates the contents of a multiple session compact disc according to the present invention;

FIG. 3 is a block diagram illustrating the interaction between a user computer and a central music server according to the present invention;

FIG. 4 is a flow diagram illustrating a digital content concealment and authorized distribution method according to the present invention;

FIG. 5 illustrates the standard subcode structure for audio CDs;

FIG. 6 illustrates the standard channel Q data format for the subcode structure of FIG. 5;

FIG. 7 illustrates the standard mode 1 Data-Q lead-in track format for the channel Q data format of FIG. 6;

FIG. 8 illustrates the standard mode 1 Data-Q audio and lead-out track format for the channel Q data format of FIG. 6;

FIG. 9 is a table illustrating an example of a table of contents (TOC) according to the present invention for a first session of a CD;

FIG. 10 is a table illustrating an example of a table of contents according to the present invention for a second session of a CD;

FIG. 11 is a table illustrating an example of modified CRC values in the channel Q data of the program area of a CD according to the present invention;

FIG. 12 is a table illustrating an example of modified ATime values in the channel Q data of the program area of a CD according to the present invention; and

FIG. 13 is a table illustrating a second example of modified ATime values in the channel Q data of the program area of a CD according to the present invention.

### DETAILED DESCRIPTION OF THE PREFERRED EMBODIMENT(S)

Referring now to the drawings, wherein like reference numerals designate corresponding structure throughout the views, an apparatus and method is provided for concealing digital content on a physical medium such as, for example, a CD and controlling authorized distribution of digital content related to the content stored on the CD. The present invention is discussed below in the non-limiting example of an audio CD, but may be generally used with other types of digital storage media including, for example, CD-ROMs, CD-Rs, and DVDs. Accordingly, the present invention extends to and is useful with these other media.

According to the present invention, digital content on a CD is concealed by making modifications to the control data that is located in the so-called “lead-in area” and stored along with the audio content on the CD. Modifications are also made to certain error checking and timing values that are located in the so-called “program area” and used to respectively verify a lack of errors in the associated control data and provide timing information. These modifications are discussed in more detail below.

In addition, according to the present invention, the CD is also made into a multiple session CD having first and second sessions in which the first session actually contains audio data, but is coded to indicate that it contains digital data. The second session contains standard digital data including features that will give the user access to protected versions of the original audio content. For instance the second session may include an HTML file that points to the Internet Uniform Resource Locator (URL) of a central music license server for permitting the downloading of protected digital music files from the server. In another solution the files may already be present on the CD but require a license key to be downloaded before they can be accessed. When the CD is placed into a personal computer, the first session, and hence the audio content, is not readable by the computer. Instead, the computer activates the contents of the seconds session by providing controlled access to a digital music file or files corresponding to the same content stored in the audio portion of the first session. The foregoing and other aspects of the present invention are discussed in more detail below.

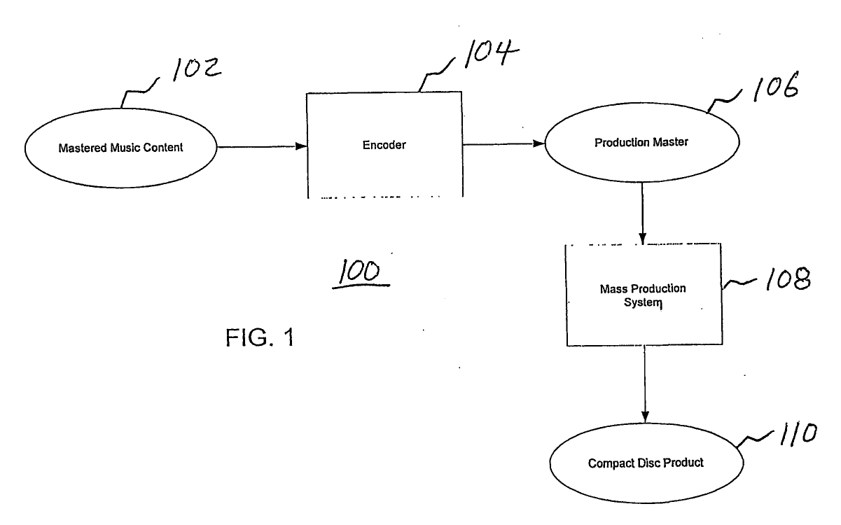

FIG. 1 is a process flow diagram illustrating a CD manufacturing production flow 100. Mastered music content 102 is provided to an encoder 104. Mastered music content 102 is in an industry standard data format, and encoder 104 is, for example, an encoding system sold under the name media input system (MIS) by Doug Carson & Associates. According to the present invention, the software used to operate encoder 104 is modified to encode the control and error checking value modifications that are described in more detail below, but in general no hardware modifications to encoder 104 are necessary.

A production master 106 is made using encoder 104, and mass production system 108 uses master 106 to create commercial quantities of compact disc product 110. Production master 106 is of standard physical construction, but the information coded into the physical structure of master 106 reflects the changes from music industry standards imparted by encoder 104 as a result of the modifications of the present invention described below.

Mass production system 108 typically performs error checking as part of the production process. The software used to operate system 108 is modified to accommodate the modifications to the error checking values as discussed below. Compact disc product 110 is of standard physical construction, and the contents of product 110 incorporate the control and error checking value modifications described herein.

Compact disc manufacturing and production technology is established according to a series of international publications, herein referred to as “standards”, all of which are incorporated herein by reference as if set forth fully herein. For example, some common standards applicable to CDs include: the International Standards Organization (ISO) standard 9660 entitled “Information Processing-Volume and File Structure of CD-ROM for Information Interchange, ISO Standard 13490-1”, the International Electrotechnique Commission (CEI-IEC) standard 908, also known as the “Red Book”, and ISO/IEC 10149, also known as the “Yellow Book”.

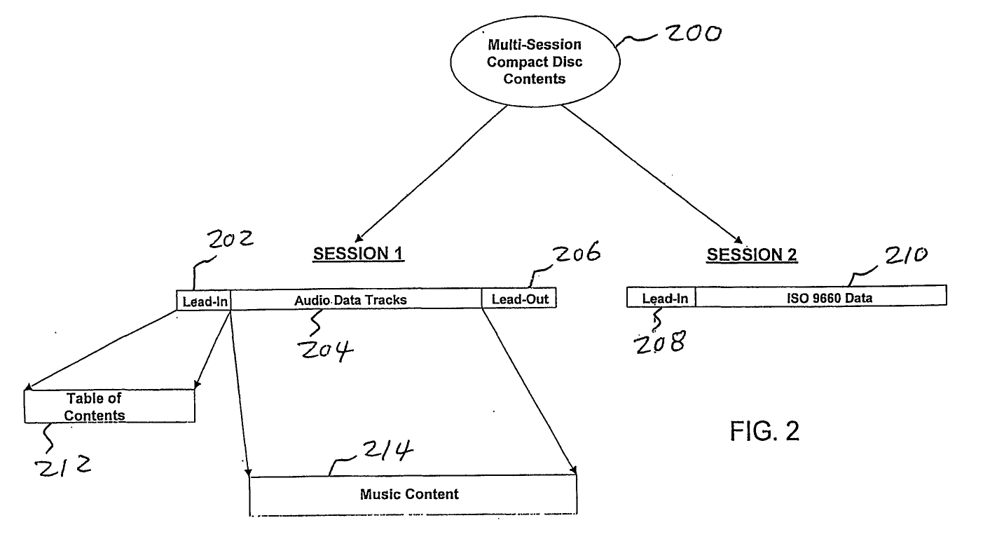

FIG. 2 illustrates the contents 200 of a multiple session compact disc made according to the present invention. Compact disc product 110 contains contents 200. As mentioned above, according to the present invention, contents 200 corresponds to a multiple session CD having sessions indicated as SESSION 1 and SESSION 2 in FIG. 2.

SESSION 1 contains a lead-in area 202, a program area 204, and a lead-out area 206. Program area 204 contains data tracks containing audio music content 214, and lead-in area 202 contains a table of contents 212 corresponding to these data tracks. Lead-out area 206 acts as a spacer between sessions and indicates the location of SESSION 2 on CD product 110. The storage format-of the digital content in SESSION 1 conforms to industry standards except as discussed herein. Certain modifications (discussed below) are made to control values associated with table of contents 212. These modifications include the addition of extra entries in the lead-in for each record beyond the standard 3 defined in the standard. These modifications further include identifying SESSION 1 as digital data in the first number of valid TOC entries, and as audio data in the remaining instances, even though SESSION 1 actually contains audio data tracks in program area 204. Alternate variations of identifying each TOC entry as data or audio shall fall within this present invention. Certain other modifications (also discussed below) are made to error checking values associated with control information stored with music content 214.

SESSION 2 contains a lead-in area 208 and a user data area 210 containing digital data. The storage format of the digital content in SESSION 2 conforms to industry standards for digital data sessions, and in particular, the data stored in user data area 210 conforms to the ISO 9660 standard for CD-ROM data storage. User data area 210 contains an information file, for example, that is automatically read by the operating system when a computer reads SESSION 2, a standard HTML file accessed by the information file, and encryption data.

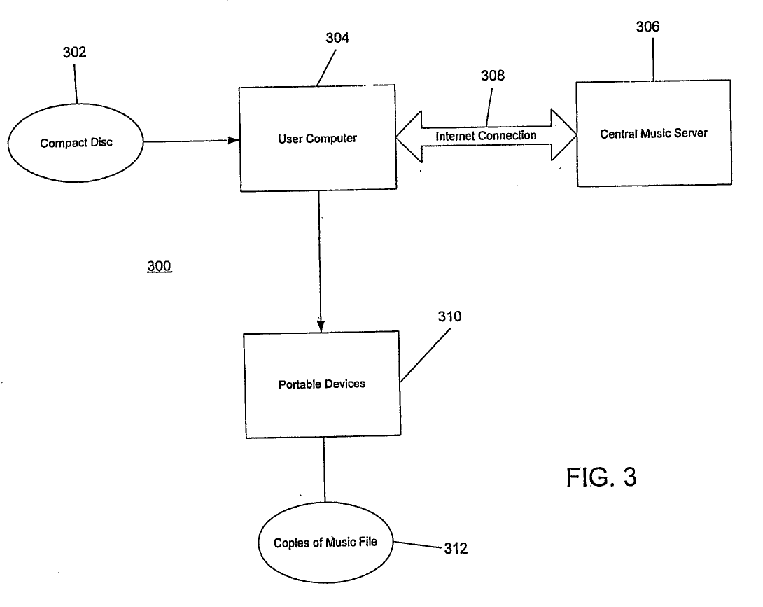

FIG. 3 is a block diagram illustrating the interaction between a user computer 304 and a central music server 306 in a digital content computer distribution system 300. According to the present invention, when a compact disc 302, manufactured as described herein, is mounted in user computer 304, audio music content 214 cannot be read by user computer 304 because the control data of SESSION 1 identifies SESSION 1 as digital data. When user computer 304 attempts to read program area 204 as digital data, user computer aborts reading the data because the audio content in program area 204 does not conform to the ISO 9660 data standard.

Because CD 302 is a multiple session CD, after user computer 304 aborts reading SESSION 1, user computer 304 next attempts to read SESSION 2 as is standard and successfully reads the information stored in user data area 210, which contains an information file read by the operating system that launches a program to gain access to the protected audio contents. For instance, it may launch an Internet browser software program, such as Microsoft Internet Explorer or Netscape Navigator, to display a website pointed to by the URL stored in an HTML file in user data area 210. The website is hosted by central music server 306 through an Internet or other communications connection 308. The user of user computer 304 may securely download a digital music file from server 306 using the encryption data stored in user data area 210, or the user may download the encryption data to open protected audio files stored in data area 210. The format of the music file may be, for example, a compressed MP3 format. Acquiring access to the music file requires that CD 302 be present in user computer 304 since it contains essential information necessary to create the encryption keys. The user of user computer 304 may make copies 312 of the music file on portable devices 310 such as, for example, portable MP3 players. The music file may be stored on user computer 304 in a protected form using a digital rights management system, such as Microsoft's Windows Media Rights Management System, that determines the rights that the user has to make copies 312.

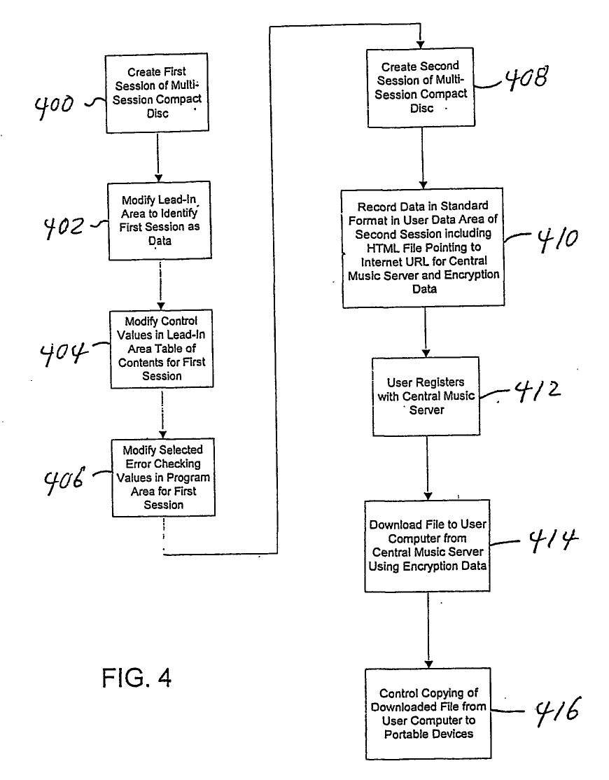

FIG. 4 is a flow diagram illustrating the digital content concealment and authorized distribution method according to the present invention. In step 400, a first audio session of multiple session CD 302 is created. In step 402, lead-in area 202 is modified to identify the first session as containing data.

In step 404, selected control values in table of contents 212 are set to non-standard values (as discussed below). In step 406, selected error checking values in program area 204 are modified to non-standard values. The modifications of steps 404 and 406 are done to conceal or prevent reading of musical content 214 by personal computers and other types of CD copiers and readers.

In step 408, a second session of CD 302 is created. In step 410, an HTML file and encryption data are stored in user data area 210. In step 412, after connection with central music server 306, a user registers with server 306 to become authorized to download a music file. Alternatively, a user registers with server 306 to become authorized to access a protected music file stored on SESSION 2.

In step 414, a music file is downloaded to user computer 304 using the encryption data stored in user data area 210. In step 416, copying of the downloaded music file to portable devices 310 is controlled, for example, using a digital rights management system.

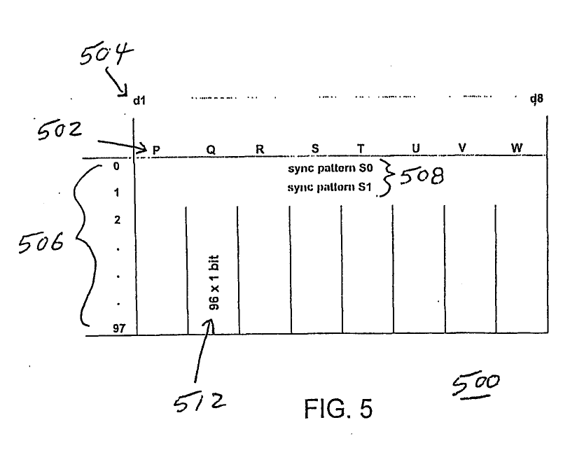

FIG. 5 illustrates the subcode structure 500 according to the standards for audio CDs. In general, data is stored on an audio CD in standard so-called “frames” in program area 204, where each single frame corresponds to 1/75^{th} of a second of playing time. Each frame contains the audio content for that time period and also contains additional control and error checking information stored in a portion of the same frame. The control information is split into 8 channels 502 (indicated by the letters P, Q, R, S, T, U, V, and W) as defined in the standards such as, for example, in the Red Book.

The channels are stored in the frame in an interleaved manner according to the standards in so-called 98 small frames indicated as 0, 1, 2 . . . 97 at reference number 506. Small frames 0 and 1 are reserved by the standards for sync patterns S0 and S1 (indicated by reference number 508), which are only used internally within the CD player hardware and do not store any actual channel data The remaining 96 small frames each store 1 bit of channel data, indicated as bits d1 . . . d8 (indicated by reference number 504) so that each channel stores 96 bits per frame. These 96 bits are indicated for the Q channel by reference number 512. Each of small frames 506 in subcode structure 500 contains 8 bits (to form a single control byte in the interleaved frame structure mentioned above), and each frame contains a total of 96 such control channel bytes.

Frames are also used to store data in lead-in area 202. Table of contents 212 is typically stored in the Q channel of each frame of lead-in area 202, and the audio content of each frame in the lead-in area is typically zero.

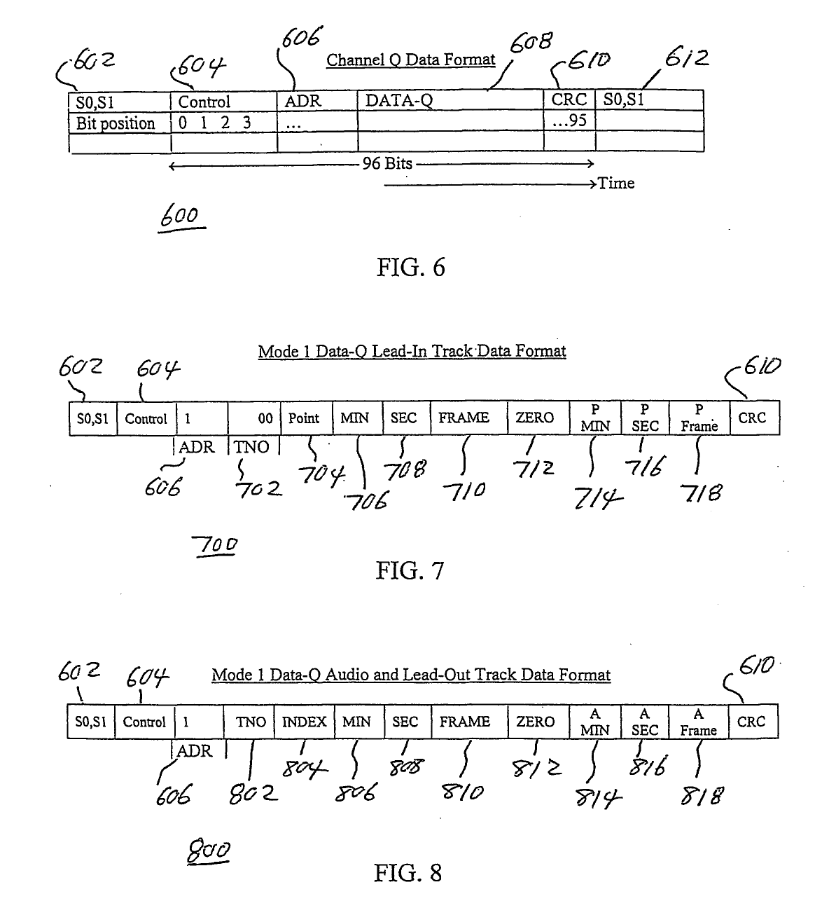

FIG. 6 illustrates the standard channel Q logical data format 600 for subcode structure 500. As mentioned above, the Q channel for each frame stores 96 bits of data, which is structured as indicated in data format 600. Fields 602 and 612 correspond to the standard sync patterns mentioned above and are not part of the Q channel data.

The Q channel data is structured into fields 604, 606, 608, and 610. Field 604 is a control field that defines, among other things, whether data in the program area of a CD is audio or digital data. Field 606 is an address field that indicates the mode for a subset of format 600 (discussed below). Field 608 contains the data bits for the Q channel, and field 610 contains error checking values, which are implemented in the standards as a cyclical redundancy check (CRC) on the control, address, and data fields 604, 606, and 608.

FIG. 7 illustrates the standard mode 1 Data-Q lead-in track format 700 for the channel Q data format 600 of FIG. 6. The format in FIG. 7 is used to store the information for table of contents 212 on CD 302. By industry practice, audio CDs typically use standard mode 1 as the value for address field 606 in lead-in area 202, indicated by a value of 1 in the ADR field of FIG. 7. The fields corresponding to DATA-Q field 608 are standard fields 702-718 as defined in the standards. The TNO field is set by the standards to zero for all records in table of contents 212.

FIG. 8 illustrates the standard mode 1 Data-Q audio and lead-out track format 800 for the channel Q data format 600 of FIG. 6. The format in FIG. 8 is used to store the channel Q data for music content 214 in program area 204. By industry practice, audio CDs also use standard mode 1 as the value for address field 606 in the program and lead-out areas 204 and 206. The fields corresponding to DATA-Q field 608 for audio and lead-out track data are standard fields 802-818 as defined in the standards.

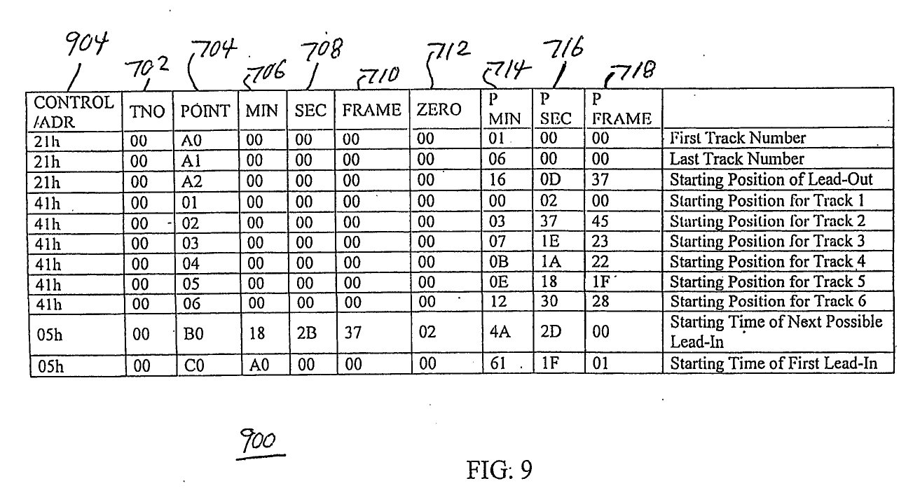

FIG. 9 is a table 900 illustrating an example according to the present invention of table of contents 212 for SESSION 1 of CD 302. Table 900 is a simplified version of the data in an actual table of contents, which according to the standards has each record repeated three times and the entire set of records repeated several times throughout lead-in area 202. Each record (or row) in table 900 corresponds to a single flame or 1/75^{th} second of lead-in running time on CD 302.

Column 904 of table 900 contains values in hexadecimal form that correspond to the values of the 8 bits contained in control and address fields 604 and 606 of FIGS. 6-8. Table 900 also contains the corresponding exemplary values for standard fields 702-718 of the Q channel data format.

According to the present invention, the control/address (also referred to herein as “control”) values in column 904 are set in non-standard ways to conceal music content 214. For those frames in which the POINT field has a value between 1 and 99, which corresponds to a track number, the control/address byte in column 904 is set to 41 h. This value identifies the record as a mode 1 record and identifies CD 302 as having digital data in program area 204. It should be recalled that the contents of program area 204 are actually recorded as standard audio data. Identifying the track data as digital data prevents program area 204 from being read by substantially most personal computers and also prevents digital audio extraction using substantially most of the hardware and software currently available for such purpose including, for example, most ripping software programs. The concealment of the digital audio content is accomplished because computers and ripping software usually check the table of contents to determine the location of the audio content on CD 302 (i.e., the starting and ending points of the data tracks). Because the table of contents identifies each track as being digital data, most computers and ripping software do not operate to extract and/or play music content 214 from CD 302.

Although computers are not able to read content from program area 204, audio CD players are able to play music content 214 from program area 204 because such players do not check the control values stored in table of contents 212. Thus, such audio players are not affected by the identifying of stored content as data content rather than as audio content.

For those frames in which the POINT field is equal to the standard values of A0, A1, and A2 (which correspond to a specific standard type of table of contents information relating to the location of the first and last data tracks and the lead-out), the control/address byte is set to a hexadecimal value of 21 (indicated as 21 h). This value identifies the record as a mode 1 record and CD 302 as having audio data in the program area. This value is selected to be different from the control value of 41 h for those frames in which the POINT field has a track number value so that the control byte value is changed more frequently than is permitted under the standards. As a result, some computer systems such as, for example, an APPLE MACINTOSH computer operating under the MAC OS 9.0 operating system, will not read music content 214 from program area 204. This occurs because the MAC OS 9.0 operating system expects table of contents 212 to be compliant with the Red Book standards. According to the standards, the control byte value, if changed, must last at least 2 seconds, which corresponds to 150 frames.

The last two rows of table 900 have the control/address byte set to 05 h. This corresponds to a standard control byte used to indicate that CD 302 is a multiple session CD, which corresponds to a so-called mode 5 under the standards. Specifically, these two mode 5 records are used to identify the starting time of the lead-in areas for each of the first and second sessions of CD 302.

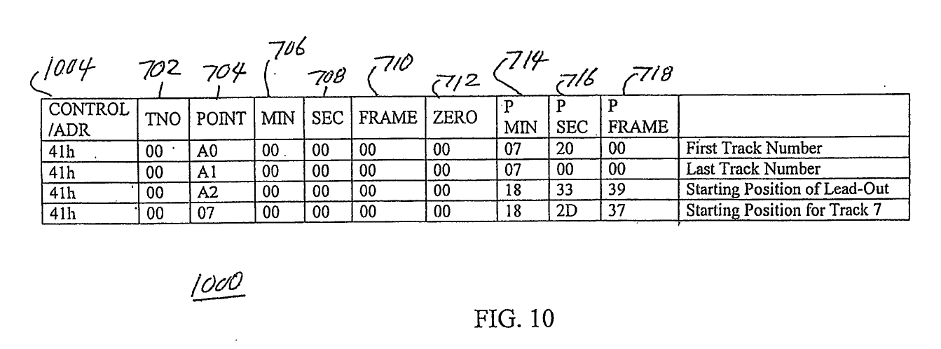

FIG. 10 is a table 1000 illustrating an example according to the present invention of a table of contents for SESSION 2 of CD 302. Lead-in area 208 uses the Q channel to store table of contents information similarly as discussed above for SESSION 1. Table 1000 is a simplified version of the data in the actual table of contents, as discussed above for FIG. 9. The presence of SESSION 2 on CD 302 aids in the prevention of digital audio extraction because some ripping software programs do not operate on multiple session CDs.

Column 1004 of table 1000 contains values in hexadecimal form that correspond to the values of the 8 bits contained in control and address fields 604 and 606 of FIGS. 6-8. Table 1000 also contains the corresponding exemplary values for standard fields 702-718 of the Q channel data format discussed above.

According to the present invention, the control bytes in column 1004 are set to a value of 41 h to indicate that the record is a mode 1 record in the Q channel and that user data area 210 contains digital data stored according to the ISO 9660 standards. The control value of 41 h corresponds correctly to the type of data stored in SESSION 2. When CD 302 is placed into user computer 304 (see FIG. 3), as discussed above it encounters a read error when attempting to read SESSION 1 and next attempts to read SESSION 2 according to the standards. User computer 304 is able to normally read the digital data from SESSION 2 and establish Internet connection 308 to central music server 306.

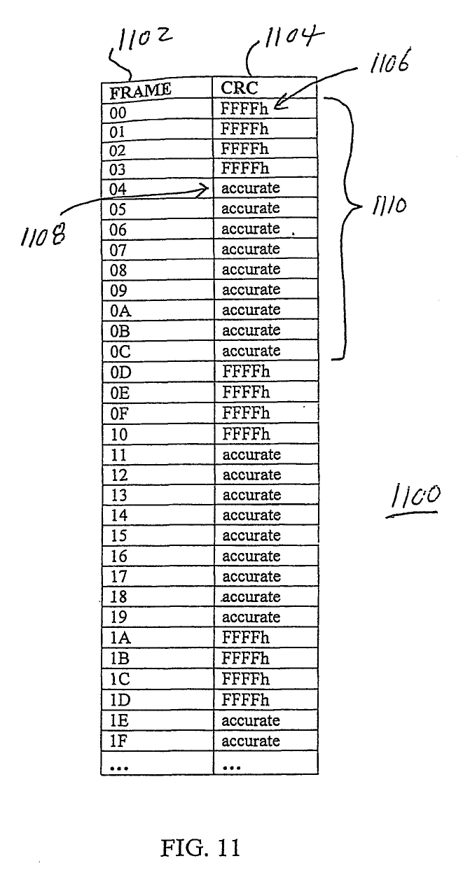

FIG. 11 is a table 1100 illustrating an example of modified CRC values in the channel Q data of program area 204 of CD 302. According to the present invention, in addition to the modifications made to the control values as discussed above, changes are also made to the error checking values, implemented here in the Q channel as CRC values in field 610 (see FIG. 6). In general ,a certain proportion of the CRC values for the audio content in program area 204 of SESSION 1 are modified to periodically repeat throughout program area 204 as discussed in more detail below. These modifications are made beginning 5 seconds into each track of program area 204 and continuing throughout all frames of subject track, and repeating in a similar manner for every track in user program 204.

Column 1102 of table 1100 lists exemplary frame addresses in hexadecimal format starting with address 00. For purposes of illustration, the starting logical block address for the first frame is 00, but it should be appreciated that the actual first frame in the program area 204 typically corresponds to the beginning of a standard period of silence (typically having a duration of two seconds and known as “pre-gaps”) immediately following the frames for the table of contents and has a logical block address of, for example, FFFFFF6Ah. According to the present invention, modified CRC values are used starting with the first frame residing 5 seconds into each track from the beginning of the standard 2 second “pre-gap” and continuing throughout the audio track, and then repeated in a similar fashion for each track in the program area 204.

Column 1104 indicates the CRC value stored onto CD 302 for each frame in program area 204. According to the present invention, a set number of initial frames in each period of frames is intentionally set to an inaccurate value, here shown, for example, as FFFFh, which does not accurately correspond to the DATA-Q values stored in field 608 (see FIG. 6). Inaccurate CRC values other than FFFFh could also be selected.

Column 1104 illustrates a frame period 1110 of every 13 frames with the first four frames 1106 of each period set to an inaccurate FFFFh value. The other 9 frames 1108 are set to accurate CRC values according to the standards.

Other variations could be made to the particular inaccurate CRC pattern used according to the invention. For example, the period could be changed to be greater than 13 frames such as, for example, 75 or 150 frames. Also, the proportion of inaccurate CRC values within each period could be increased or decreased. Further, the inaccurate CRC values could be scattered throughout each period rather than being located in a single group of consecutive frame addresses.

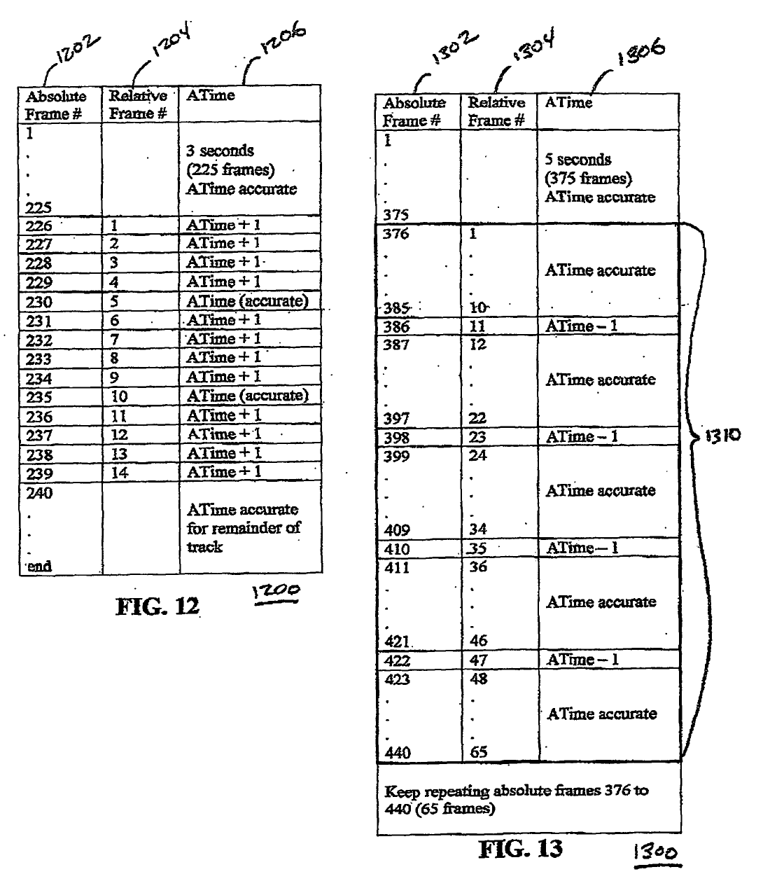

FIG. 12 is a table 1200 illustrating an example of modified ATime values in the channel Q data of program area 204 of CD 302. According to the present invention, in addition to the modifications made to the control values as discussed above, changes are also made to the ATime values, implemented here in the Q channel as ATime errors in fields 814 and 816 (see FIG. 8). In general, a certain proportion of the ATime values for the audio content in program area 204 of SESSION 1 are modified in within each track of program area 204 as discussed in more detail below. These modifications are made beginning at 3 seconds into each track, assuming a 2 second pregap, of program area 204 and continuing over a series of 14 frames only of subject track, and repeating in a similar manner for every track in user program area 204.

Column 1202 of table 1200 lists exemplary frame addresses in hexadecimal format starting with address 00. For purposes of illustration, the starting logical block address for the first frame is 00, but it should be appreciated that the actual first frame in the program area 204 typically corresponds to the beginning of a standard period of silence (typically having a duration of 2 seconds and known as “pre-gaps”) plus some delay (here having a duration of 1 seconds for a total of a 3 second delay) immediately following the frames for the table of contents and has a logical block address of, for example, FFFFFF6Ah. According to the present invention, modified ATime values are used starting with the first frame of this period of silence plus the 1-second delay of each audio track and repeating in a similar manner for every track in user program area 204.

Column 1206 indicates the ATime value stored onto CD 302 for each frame in program area 204. According to the present invention, a set number of frames is intentionally set to an inaccurate value, here shown, for example, as being one frame more than it should be, which does not accurately correspond to the actual ATime values. Inaccuracies in the ATime values greater than 1 frame could also be selected.

Column 1204 illustrates that frames 1-4, 6-9, 11-14 1207 each have ATime values which are 1 frame more than it should be starting 3 seconds after the start of the pregap (assuming a pregap of 2 seconds in length). The other flames 1208 are set to accurate Atime values according to the standards. Inaccuracies could have been introduced into frames other thanframes frames 1-4, 6-9, and 11-14.

Other variations could be made to the particular inaccurate ATime pattern used according to the invention. For example, the number of frames could be changed to be greater or less than 14 frames such as, for example, 12 or 18 frames. Also, the proportion of inaccurate ATime values within each period could be increased or decreased. Further, the inaccurate ATime values could be scattered differently throughout each period rather than being located where currently illustrated.

FIG. 13 is a table 1300 illustrating an example of modified ATime values in the channel Q data of program area 204 of CD 302. According to the present invention, in addition to the modifications made to the control values as discussed above, changes are also made to the ATime values, implemented here in the Q channel as ATime errors in fields 814 and 816 (see FIG. 8). In general, a certain proportion of the ATime values for the audio content in program area 204 of SESSION 1 are modified to periodically repeat throughout program area 204 as discussed in more detail below. These modifications are made beginning at 5 seconds into each track, assuming a 2 second pregap, of program area 204 and continuing periodically every 65 frames throughout all frames of subject track, and repeating in a similar manner for every track in user program 204.

Column 1302 of table 1300 lists exemplary frame addresses in hexadecimal format starting with address 00. For purposes of illustration, the starting logical block address for the first frame is 00, but it should be appreciated that the actual first frame in the program area 204 typically corresponds to the beginning of a standard period of silence (typically having a duration of 2 seconds and known as “pre-gaps”) plus some delay (here having a duration of 3 seconds for a total of a 5 second delay) immediately following the frames for the table of contents and has a logical block address of, for example, FFFFFF6Ah. According to the present invention, modified ATime values are used starting with the first frame of this period of silence plus the delay and continuing throughout each audio track and repeating in a similar manner for every track in user program area 204.

Column 1306 illustrates a frame period 1310 of every 65 frames such that frames 11, 23, 35 and 47 1307 each have ATime values which are 1 frame less than it should be starting 5 seconds after the start of the pregap (assuming a pregap of 2 seconds in length). The other frames 1308 are set to accurate ATime values according to the standards. Inaccuracies could have been introduced into frames other than frames 11, 23, 35, and 47.

Column 1304 illustrates that frames 11, 23, 35 and 47 1307 each have ATime values which are 1 frame less than it should be starting 5 seconds after the start of the pregap (assuming a pregap of 2 seconds in length). Inaccuracies could have been introduced into frames other than frames 11, 23, 35, and 47.

Additionally, other modifications (Additional Errors) to certain control data are made which have the effect of enhancing copy protection. Such other modifications may include: Setting the CTL/ADR byte to 01 h in SESSION 1; setting frame 1 CTL/ADR to 41 h and TRACKNO to 0 every 65 frames; setting the frame 1 ATime value in every other 65 frame period to a value which is one frame less than it should be (this change shall coincide with a CRC error, a CTL/ADR error and a TRACKNO error).

It has been found that most computers and digital audio extraction software such as ripping software will not operate to extract audio data from CD 302 when the periodic CRC errors or ATime errors or Additional Errors described above are present. However, it has been learned that substantially most CD audio players, including shock resistant models, will still play music content 214 from program area 204 even though it contains periodic CRC, ATime and Additional errors. Most such audio players calculate a CRC value during play and compare it to the CRC value of column 1104. Such audio players are designed to tolerate a certain minimal number of CRC errors and continue playing. It has been found that modifications to the CRC in the first four frames of every 13 frames is tolerated by most such audio players. Furthermore, it has been determined that modifications to the ATime in certain frames are similarly tolerated by most such audio players.

The selection of the period and number of bad CRC and ATime values used in each period is a process of balancing playability on audio CD players against preventing computers and digital audio extraction software from being able to extract audio content. In other words, it is desired that the proportion of frames with inaccurate CRC be high to defeat ripping software, without being so high that audio CD players are unable to play the audio content.

The CRC modifications described above could also be made to lead-out area 206, but this is not necessary to accomplish the benefits of the present invention. Lead-in area 202 and all of SESSION 2 do not have the above CRC modifications made.

By the foregoing description, a novel apparatus and method for the concealment of digital content have been disclosed. The present invention has the advantages of protecting published content from unauthorized distribution. Publishers are able to offer a broader range of audio and video material at lower prices due to a reduction in the loss of profits to unauthorized distribution and pirating. Further, CDs produced according to the present invention are playable in most audio CD players, including shock resistant types, but are not playable in most computer systems and thus cannot be duplicated by ripping software or other software programs using digital audio extraction. Moreover, according to the present invention, the audio music content is not modified and is instead identical to that produced using industry standard mastering techniques, and accordingly, there is no audio playback degradation when the CD is played on audio players.

The digital content concealment approach described above is readily implemented at the CD replication site by a software upgrade to the encoder used to create CD masters and to the error checking station software so that CDs using the present concealment approach can be checked for errors.

Although specific embodiments have been described above, it will be appreciated that numerous modifications and substitutions of the invention may be made. For example, the present invention may be applied to other types of formats such as, for example, CD-ROM, CD-R, CD-i, DVD-A, and CDR-G formats. Accordingly, the invention has been described by way of illustration rather than limitation.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the fill extent indicated by the broad general meaning of the terms in which the appended claims are expressed.

What is claimed is:

1. A compact disc, comprising:
digital audio content; and
a lead-in area, said lead in area having control data stored thereon, and wherein said control data is configured in such manner as to conceal said digital audio content from a user computer.

2. A compact disc according to claim 1, wherein said compact disc is configured as a multiple session disc, and wherein said digital audio content is located on a first session.

3. A compact disc according to claim 2, further comprising a second session that is configured to direct a user computer to an alternative form of audio content that is subject to a digital rights management protocol.

4. A compact disc according to claim 3, wherein said second session is configured to direct a user computer to an alternative source of audio content, and wherein said alternative source comprises a music server.

5. A compact disc according to claim 4, wherein said music server comprises a music server that is accessed via the Internet.

6. A compact disc according to claim 1, wherein said control data is configured so as to misleadingly identify said digital audio content to a user computer as data.

7. A compact disc according to claim 6, wherein said control data is configured so as to have a Q channel format that is atypical for digital audio content.

8. A multiple session compact disc, comprising:
a first session containing digital audio content;
a second session that is configured to provide a user computer with access to an alternative form of the audio content that is subject to a digital rights management protocol; and
concealment means for concealing the presence of digital audio content on said first session to a user computer.

9. A multiple session compact disc according to claim 8, wherein said second session is configured to direct a user computer to an alternative source of audio content, and wherein said alternative source comprises a music server.

10. A multiple session compact disc according to claim 9, wherein said music server comprises a music server that is accessed via the Internet.

11. A multiple session compact disc according to claim 8, wherein said concealment means is configured to frustrate a user computer from reading said first session, whereby the user computer will be directed to the alternative form of the audio content that is accessed through the second session.

12. A multiple session compact disc according to claim 8, wherein said concealment means is configured to misleadingly identify the digital audio content that is contained in the first session as data.

13. A multiple session compact disc according to claim 8, wherein said concealment means comprises control data that is located on a lead in area of the compact disc, said control data being configured to misleadingly identity the digital audio content that is contained in the first session as data.

14. A multiple session compact disc according to claim 13, wherein said control data is configured so as to have a Q channel format that is atypical for digital audio content.

15. A method of providing access to digital music content that is subject to a digital rights protocol to a user computer, comprising steps of:
providing a copy protected compact disc having a first session that contains digital audio content, a second session that is configured to provide a user computer with access to an alternative form of the digital audio content that is subject to the digital rights protocol, and copy protection that is configured to frustrate the user computer from digitally extracting the digital audio content that is contained on the first session;
placing the copy protected compact disc into a CD-ROM drive that is operatively connected to a user computer;
directing the user computer to the alternative form of digital audio content that is contained on the second session.

16. A method according to claim 15, wherein said step of directing the user computer to the alternative form of digital audio content that is contained on the second session comprises directing the user computer to communicate with a music server.

17. A method according to claim 16, wherein said step of directing the user computer to the alternative form of digital audio content that is contained on the second session comprises directing the user computer to communicate with a music server via the Internet.

18. A method of providing copy protection to a compact disc containing digital audio content, comprising steps of:
applying the digital audio content to the compact disc; and
applying a lead-in portion to the compact disc that is configured to frustrate recognition of the digital audio content by a user computer.

19. A method of providing copy protection to a compact disc according to claim 18, wherein said step of applying a lead-in portion comprises applying control data that is configured to misleadingly identify the digital audio content that is contained in the first session as data.

20. A multiple session compact disc according to claim 19, wherein said step of applying a lead in portion is further performed by applying control data that is configured so as to have a Q channel format that is atypical for digital audio content.
